(19) United States
(12) Patent Application Publication
(10) Pub. No.: US 2026/0254233 A1
(43) Pub. Date: Aug. 27, 2026

(54) DISCONNECTS FOR INDIVIDUAL POWER MODULES OF AN ELECTROCHEMICAL FUEL CELL SYSTEM

(71) Applicant: Bloom Energy Corporation, San Jose, CA (US)

(72) Inventors: Gregory Scott Seiverd, JR., Newark, DE (US); Brian Michael Hadley, Atlanta, GA (US)

(21) Appl. No.: 19/545,634

(22) Filed: Feb. 20, 2026

Related U.S. Application Data
(60) Provisional application No. 63/761,615, filed on Feb. 21, 2025.

(51) Int. Cl. H02J 1/08; H01M 8/2465

(52) U.S. Cl. CPC H02J 1/084; H01M 8/2465

(57) ABSTRACT

A power module disconnect in an electrochemical fuel cell system is configured to disconnect an individual power generation module from the system. The system includes a startup bus and a fuel cell bus, each including multiple current conductors (e.g., five total current conductors). The power module disconnect includes switches, each controlling a current conductor in a module bus corresponding to the system buses, and a manual switch. When turned to the off position, the manual switch simultaneously opens each of the switches to disconnect the module buses from the system buses. When turned to the on position, the manual switch simultaneously closes each of the switches to connect the module buses to the system buses. Accordingly, individual power generation modules can be disconnected without interrupting the entire system. Further, power module disconnects can be added to empty power generation module bays for later system expansion.

### BACKGROUND

This application claims the benefit of and priority to U.S. Provisional Patent Application No. 63/761,615, titled “DISCONNECTS FOR INDIVIDUAL POWER MODULES OF AN ELECTROCHEMICAL FUEL CELL SYSTEM,” filed February 21, 2025, the contents of which is incorporated herein by reference in its entirety for all purposes.

### BACKGROUND

Electrochemical fuel cell systems, including solid oxide fuel systems, can include power modules that generate electricity. The power modules can be connected to an alternating current (AC) module that feeds the generated power to the grid. However, during testing and in the field, there are times when disconnecting an individual power module while the remainder of the fuel cell system is still running would improve safety and performance. For example, maintenance or module swapping may require disconnecting one power module from the system. However, there is currently not a convenient or quick way to disconnect an individual power module from the rest of the system while the other modules are generating electricity due to residual voltage on the direct current (DC) buses. Accordingly, improvements are needed.

### SUMMARY

Disclosed are power disconnect modules that disconnect individual power generation modules from electrochemical fuel cell systems safely. Each power generation module that includes a power disconnect module can be individually disconnected from the overall system. Each electrochemical fuel cell system has a fuel cell (FC) bus having three conductors and a startup (S/U) bus having two conductors. The power generation modules are each coupled to all 5 conductors of the FC bus and S/U bus. Each power disconnect module is placed between its corresponding power generation module and the FC bus and S/U bus of the system. The power disconnect modules provide an indicator light signaling when power is flowing between its corresponding power generation module and the FC and S/U buses of the system. Each power disconnect module includes a handle or switch that can be alternated between the on position to the off position. When switched to the off position, the power disconnect module breaks the electrical connection for each conductor substantially simultaneously so that all 5 conductors of the FC bus and S/U bus are disconnected between the corresponding power generation module and the fuel cell system. Additionally, the frame (e.g., skid, pad) that holds the electrochemical fuel cell system includes a disconnect bay associated with a power generation module

This summary is provided as a general overview and is not intended to limit the scope of the present disclosure or the claims presented below.

### BRIEF DESCRIPTION OF THE DRAWINGS

In the drawings, like reference characters generally refer to like parts throughout the different views. Also, the drawings are not necessarily to scale, with an emphasis instead generally being placed upon illustrating the principles of the technology disclosed. In the following description, various implementations are described with reference to the following drawings.

FIG. 1 illustrates an electrochemical fuel cell system incorporating individual power module disconnects, according to an embodiment of the present disclosure.

FIG. 2 illustrates an image of an individual power module disconnect, according to various embodiments of the present disclosure.

FIG. 3 illustrates a schematic view of electrical connections for a fuel cell system with individual power module disconnects, according to various embodiments of the present disclosure.

FIG. 4 illustrates a schematic view of electrical connections in an individual power module disconnect, according to various embodiments of the present disclosure.

FIG. 5 illustrates a schematic view of exemplary components within an individual power module disconnect, according to various embodiments of the present disclosure.

### DETAILED DESCRIPTION

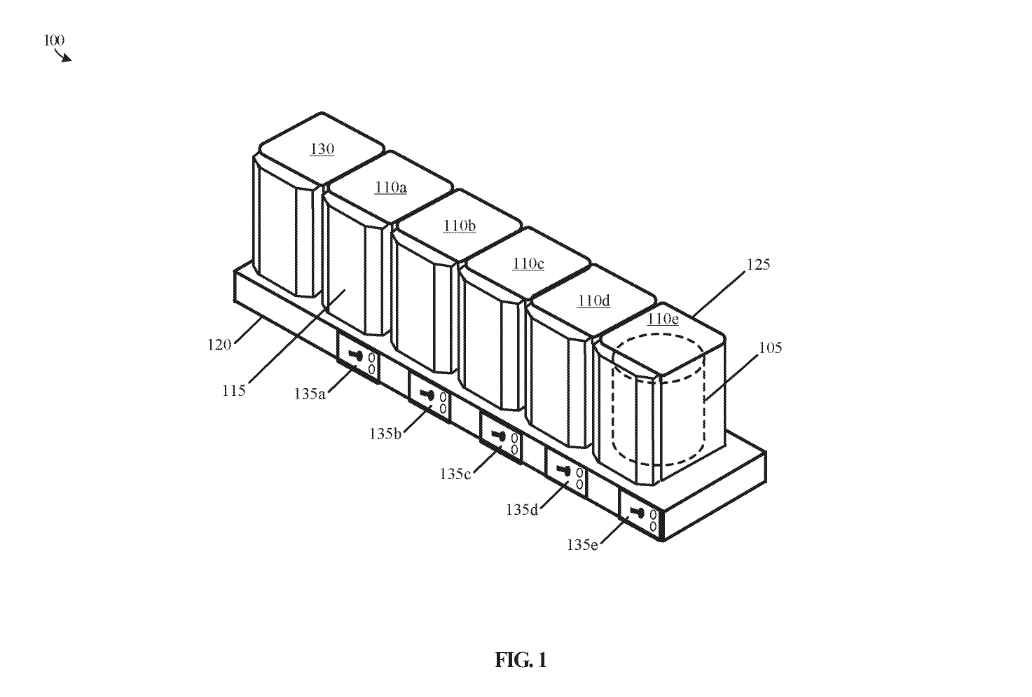

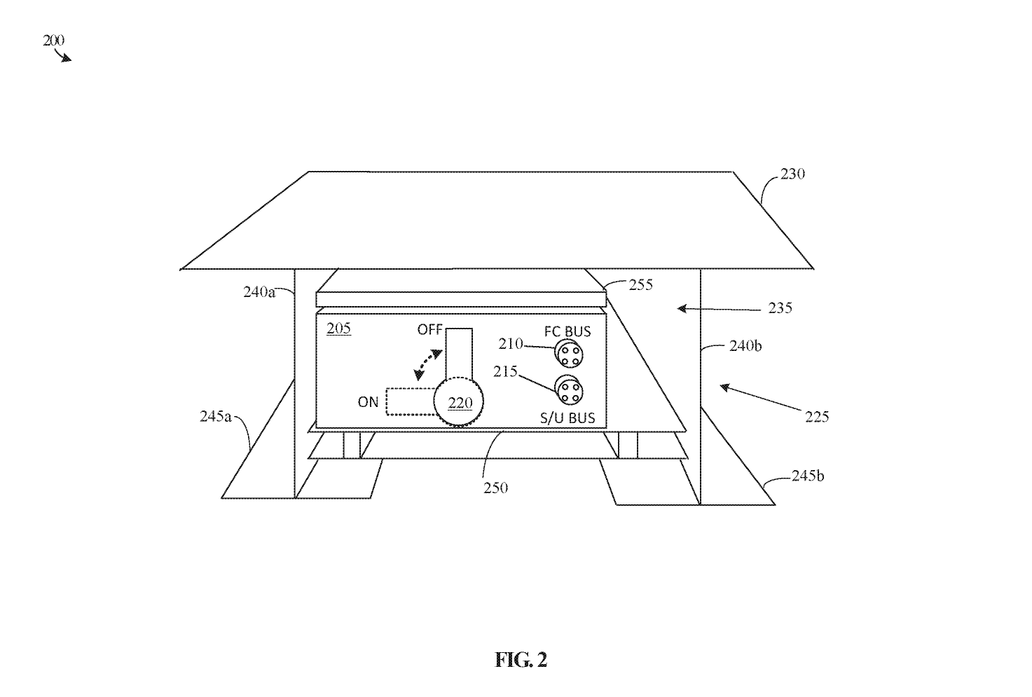

FIG. 1 is a perspective view of a modular electrochemical fuel cell system 100, such as a solid oxide fuel cell (SOFC) system, according to various embodiments of the present disclosure. The modular fuel cell system 100 may contain modules and components described in U.S. Patent Nos. 9,190,693 and 9,755,263, which are incorporated herein by reference in their entireties. The modular design of the fuel cell system 100 provides flexible system installation and operation. Modules allow scaling of installed generating capacity, reliable generation of power, flexibility of fuel processing, and flexibility of power output voltages and frequencies with a single design set. The modular design results in an “always on” unit with very high availability and reliability. This design also provides an easy means of scale up to meet specific requirements of customer installations. The modular design also allows the use of available fuels and required voltages and frequencies which may vary by customer and/or by geographic region. The addition of individual power module disconnects 135a, 135b, 135c, 135d, 135e (collectively power module disconnects 135) ensures that the “always on” functionality is safely maintained due to the ability to safely and conveniently disconnect and connect a single power generation module 110 from the fuel cell system 100. Power module disconnects 135 are discussed in more detail with respect to FIGS. 2 – 5.

Fuel cell system 100 includes one or more fuel cell power generation modules 110. Fuel cell system 100 is depicted with five power generation modules 110. Each power generation module 110 includes a hotbox 105 and a housing/cabinet 125. Fuel cell system 100 further includes one or more power conditioning modules 130. Power conditioning module 130 processes the power from power generation modules 110 and can distribute power, for example, to the public utility grid or to a local controlled microgrid. In certain embodiments, power conditioning modules 130 are configured to deliver direct current (DC). In alternative embodiments, power conditioning modules 130 are configured to deliver alternating current (AC). In these embodiments, the power conditioning modules 130 include a mechanism to convert DC to AC, such as an inverter.

Fuel cell system 100 includes a row of five power generation modules 110 and one power conditioning module 130 disposed on a pad 120. While one row of power generation modules 110 is shown, fuel cell system 100 may comprise more than one row of power generation modules 110. For example, fuel cell system 100 may comprise two rows of power generation modules 110 arranged back-to-back/end-to-end.

Each power generation module 110 is configured to house one or more hotboxes 105. Each hotbox 105 contains one or more stacks or columns of fuel cells (not shown for clarity), such as one or more stacks or columns of SOFCs having a ceramic oxide electrolyte separated by conductive interconnect plates.

The fuel cell stacks may comprise externally and/or internally manifolded stacks. For example, the stacks may be internally manifolded for fuel and air with fuel and air risers extending through openings in the fuel cell layers and/or in the interconnect plates between the fuel cells.

Alternatively, the fuel cell stacks may be internally manifolded for fuel and externally manifolded for air, where only the fuel inlet and exhaust risers extend through openings in the fuel cell layers and/or in the interconnect plates between the fuel cells, as described in U.S. Patent Number 7,713,649, which is incorporated herein by reference in its entirety. The fuel cells may have a cross flow (where air and fuel flow roughly perpendicular to each other on opposite sides of the electrolyte in each fuel cell), counter flow parallel (where air and fuel flow roughly parallel to each other but in opposite directions on opposite sides of the electrolyte in each fuel cell) or co-flow parallel (where air and fuel flow roughly parallel to each other in the same direction on opposite sides of the electrolyte in each fuel cell) configuration.

Power conditioning module 130 (also called AC module 130 herein) may include components for converting the fuel cell stack generated DC power to AC power (e.g., DC/DC and DC/AC converters described in U.S. Patent Number 7,705,490, incorporated herein by reference in its entirety), electrical connectors for AC power output to the grid, circuits for managing electrical transients, and a system controller (e.g., a computer or dedicated control logic device or circuit). Power conditioning module 130 may be designed to convert DC power from the fuel cell modules to different AC voltages and frequencies. Designs for 208V, 60Hz; 480V, 60Hz; 415V, 50Hz and other common voltages and frequencies may be provided.

In some embodiments, module 130 may also contain fuel processing equipment. In particular, module 130 may include components for pre-processing of fuel, such as adsorption beds (e.g., desulfurizer and/or other impurity adsorption) beds. The fuel processing module may be designed to process a particular type of fuel. For example, the system may include a natural gas fuel processing module or a biogas processing module. A different bed composition tailored for a particular fuel may be provided. In some designs, a separate cabinet may be provided for the fuel processing module.

The linear array of power generation modules 110 is readily scaled. For example, more or fewer power generation modules 110 may be provided depending on the power needs of the building or other facility serviced by fuel cell system 100. Power generation modules 110 and input/output modules may also be provided in other ratios. For example, in other exemplary embodiments, more or fewer power generation modules 110 may be provided.

Fuel cell system 100 may be configured in a way to ease servicing of the components of the fuel cell system 100. For example, fuel cell system 100 may include access doors 115. All of the routinely or high serviced components (such as the consumable components) may be placed in a single module to reduce the amount of time required for the service person.

For example, when one power module 110 is taken offline (i.e., no power is generated by the stacks in the hotbox 105 in the offline module 110), the remaining power modules 110 and the power conditioning module 130 are not taken offline. Furthermore, the fuel cell system 100 may contain more than one of each type of module 110, 130. When at least one module of a particular type is taken offline, the remaining modules of the same type are not taken offline.

Thus, in a system comprising a plurality of modules, each of the power generation modules 110 may be electrically disconnected using individual disconnects 135, removed from fuel cell system 100, serviced or repaired, or any combination of such without stopping the operation of the other power generation modules 110 in fuel cell system 100, allowing fuel cell system 100 to continue to generate electricity. In other words, the entire fuel cell system 100 does not have to be shut down if one stack of fuel cells in one hotbox 105 malfunctions or is taken offline for servicing.

FIG. 2 illustrates system 200 including a power disconnect module 205 and a system frame 225. System 200 may be used in production implementations or testing implementations. Power disconnect module 205 may be one implementation of power disconnect module 135. System frame 225 illustrates at least a portion of a frame that is used to support the power generation modules (e.g., power generation modules 110) and power disconnect modules (e.g., power disconnect module 205). As illustrated in FIG. 1, each power generation module can include a power disconnect module, though every power generation module may not have a corresponding power disconnect module, in some embodiments. Furthermore, empty power generation module bays or platforms in a system can include a power disconnect module for ease of later system expansion.

System frame 225 includes ground supports 245a and 245b (collectively ground supports 245), vertical supports 240a and 240b (collectively vertical supports 240), power generation module platform 230, and disconnect platform 250. While no power generation module (e.g., power generation module 110) is depicted in system 200, the power generation module corresponding to power disconnect module 205 would sit atop power generation module platform 230. System frame 225 is constructed of material (e.g., steel) to support the weight of a power generation module and a power disconnect module. The size (e.g., length, width, height, thickness) of each of ground supports 245, vertical supports 240, power generation module platform 230, and disconnect platform 250 are sized and positioned to support the physical weight and physical parameters of the power generation module 110 and power disconnect module 205. System frame 225 is generally representative of any frame or support that is used in an electrochemical fuel cell system such as pad 120. System frame 225 may be a pad, a skid, or any other suitable framing. Furthermore, in some embodiments, power generation module platform 230 is not a flat surface. For example, power generation module platform 230 may include supports similar to ground supports 245 leaving open expanses across which the power generation module sits. Furthermore, power generation module platform 230 may include vertical extensions that are used to position the power generation module and ensure it does not move horizontally across power generation module platform 230 (e.g., due to vibrations). In the depiction of system 200, vertical supports 240, power generation module platform 230, and disconnect platform 250 form disconnect module bay 235 into which power disconnect module 205 is disposed. The front of disconnect module bay 235 is exposed such that power disconnect module 205 is exposed during operation of the electrochemical fuel cell system. However, in some embodiments, a door (not shown) may provide optional exposure to power disconnect module 205 by opening and closing. Furthermore, placing disconnect module bay 235 below its corresponding power generation module that sits atop power generation module platform 230 provides ease of visual association between a given power disconnect module and its corresponding power generation module. However, disconnect module bay 235 may be positioned differently, but still associated with, its corresponding power generation module. For example, disconnect module bay 235 may be positioned offset from, adjacent to, above, or behind its corresponding power generation module platform 230 and power generation module (not shown).

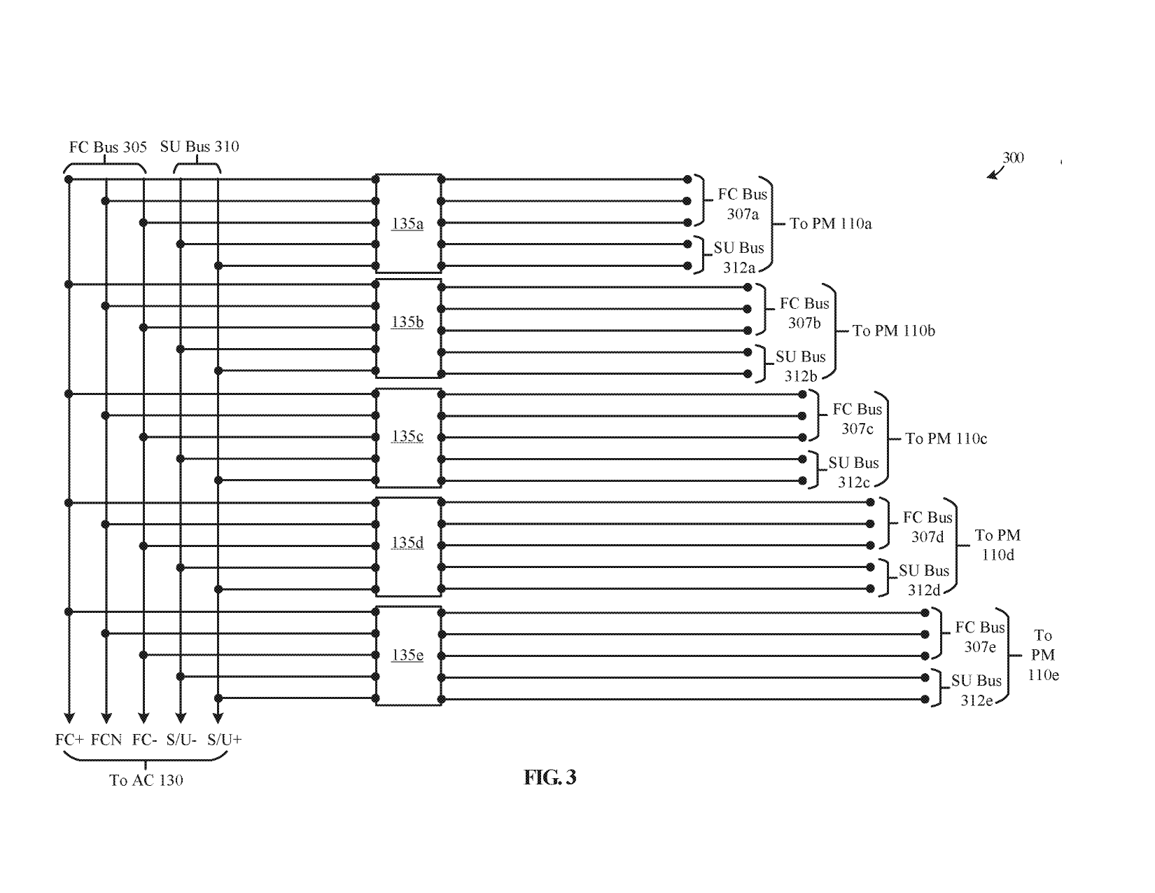

Power disconnect module 205 is placed within disconnect module bay 235 of system frame 225 in system 200. Power disconnect module 205 includes fuel cell (FC) bus indicator light 210, startup (S/U) bus indicator light 215, rotatable handle 205, and cover 255. Cover 255 may be fastened at least on one side to the main enclosure of power disconnect module 205. As such, cover 255 may be openable to maintain stability while also allowing for access to the internal switches and components of power disconnect module 205 depicted in more detail with respect to FIGS. 3 – 5. Rotatable handle 220 may be rotated between an on position and an off position. When in the on position, the power disconnect module 205 is not breaking the electrical connection between the corresponding power generation module (e.g., power generation module 110) and the power conditioning module (e.g., power conditioning module 130). When in the off position, power disconnect module 205 is breaking the electrical connection between the corresponding power generation module 110 and the power conditioning module 130. While FIG. 2 illustrates a rotatable handle 220 as one type of manual switching component, the present invention is not so limited. In particular, any suitable mechanical switch may be used, such as a single pole throw switch, a push button switch, a toggle switch, a slide switch, or the like.

Fuel cell (FC) bus indicator light 210 corresponds to the FC bus connection between the corresponding power generation module 110 and the power conditioning module 130. When no current is flowing on the FC bus, FC bus indicator light 210 is not lighted. When current is flowing on the FC bus, FC bus indicator light 210 is lighted. In some embodiments, FC bus indicator light 210 includes an indicator light corresponding to each conductor of the FC bus. The FC bus is an electrical power line that carries the usable output power produced by the fuel cell to the power conditioning module 130.

Startup (S/U) bus indicator light 215 corresponds to the S/U bus connection between the corresponding power generation module 110 and the power conditioning module 130. When no current is flowing on the S/U bus, S/U bus indicator light 215 is not lighted. When current is flowing on the S/U bus, S/U bus indicator light 215 is lighted. In some embodiments, S/U bus indicator light 215 includes an indicator light corresponding to each conductor of the S/U bus. The S/U bus is an electrical power line used at least in part to provide initial current (i.e., energy or power) required to bring the fuel cell stack and its supporting components online before the fuel cell produces power on its own. After startup, the S/U bus still has current on the bus even though the fuel cell does not draw much or any current from it during normal operation.

FIG. 3 illustrates an exemplary schematic 300 illustrating electrical connections of the FC buses and S/U buses in fuel cell system 100. Fuel cell system 100 includes power generation modules 110 and at least one power conditioning module 130 as shown in FIG. 1. The depicted electrical connections show that fuel cell system 100 includes FC bus 305 and S/U bus 310. FC bus 305 includes the positive conductor (FC+), the neutral conductor (FCN) and the negative conductor (FC-). S/U bus 310 includes the positive conductor (S/U+) and the negative conductor (S/U-).

Each power generation module 110 is coupled to the fuel cell system 100 with a module FC bus 307 and a module S/U bus 312. The module FC bus 307 includes three conductors, each coupled to one of the conductors of the fuel cell system FC bus 305. The module S/U bus 312 includes two conductors each coupled to one of the conductors of the fuel cell system S/U bus 310.

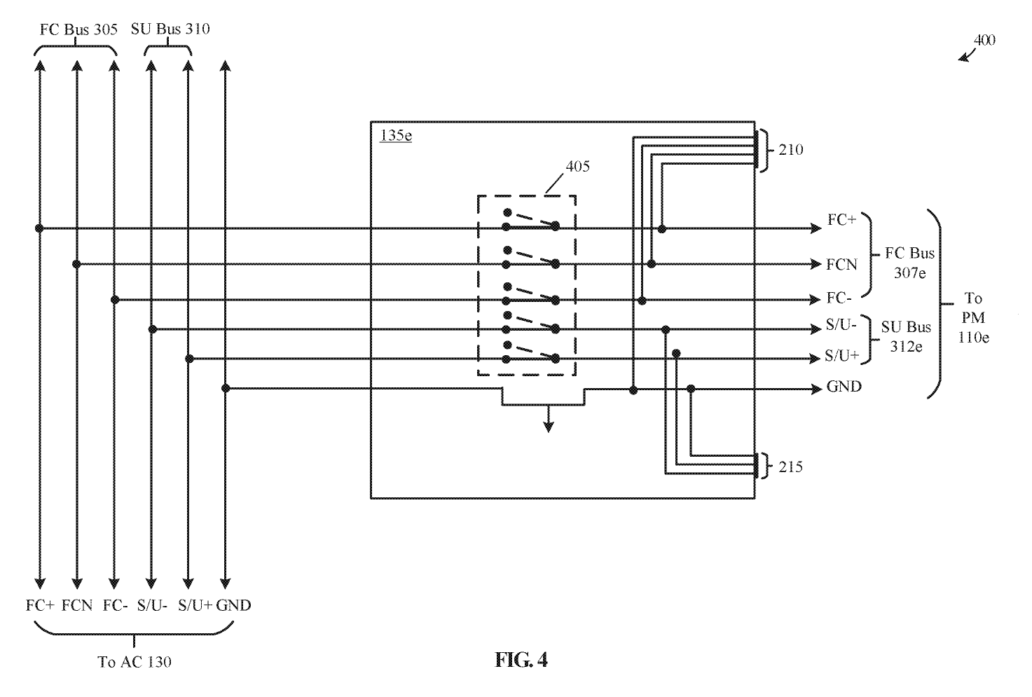

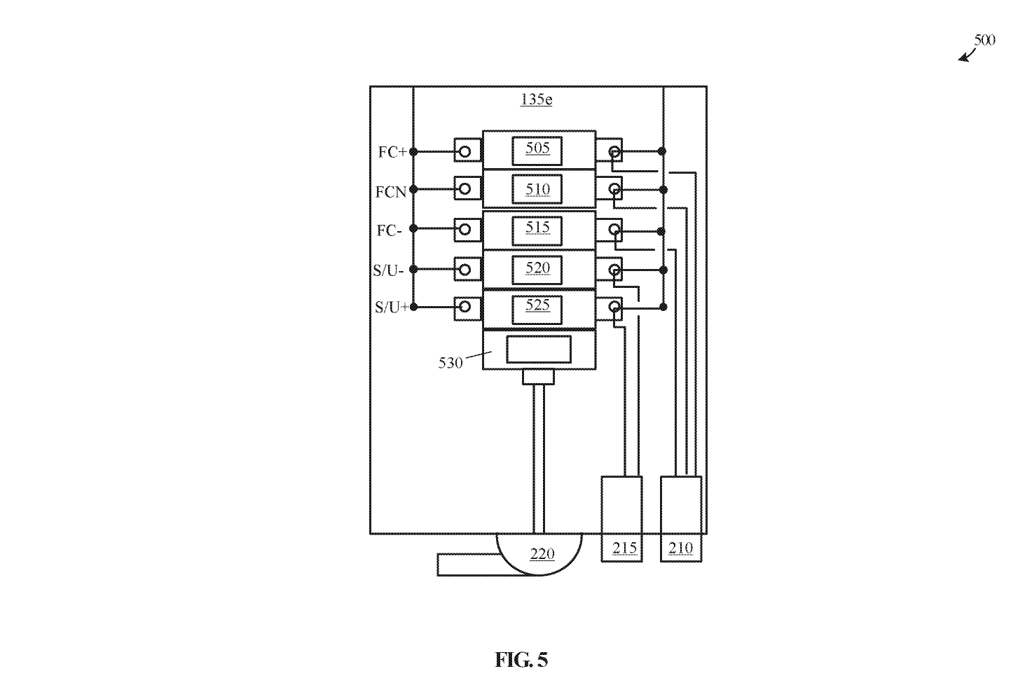

Each power generation module 110 includes a power disconnect module 135 coupled between it and the FC bus 305 and S/U bus 310 of fuel cell system 100. Further details of each power disconnect module 135 are shown in FIGS. 4 and 5. Note that while each power generation module 110 includes a power disconnect module 135, in some embodiments, not all power generation modules include a power disconnect module 135. In some embodiments, a power disconnect module 135 may be used to allow for later addition or subtraction of a power generation module 110 without impacting the remaining power generation modules 110 comprising fuel cell system 100. For example, if no power generation module 110a is installed, module FC bus 307a and module S/U bus 312a may have a connector that is capped and not connected to a power generation module. By way of example, fuel cell system 100 may be installed at a customer location with five power module cabinets 125 as illustrated in FIG. 1. A particular customer may only require three operating power modules 110 (e.g., hot boxes 105 present in power module locations 110a, 110b, and 110c). Power modules 110d and 110e would therefore be empty upon initial installation. However, by installing power module disconnects 135d and 135e during installation of the first three power modules 110a, 110b, and 110c, it will be easier and quicker to add hotboxes 105 to fuel cell system 100 at locations 110d and 110e without disrupting the operation of the other components of fuel cell system 100.

FIG. 4 illustrates an exemplary schematic 400 depicting electrical connections within one of the power disconnect modules 135e. Each power disconnect module 135a – 135e is similarly wired to illustrate the operation of FC bus indicator light 210 and S/U bus indicator light 215.

Schematic 400 illustrates that power generation module 110e includes a module FC bus 307e with three conductors, where each conductor is coupled to a corresponding conductor of FC bus 305 of fuel cell system 100. Power generation module 110e further includes a module S/U bus 312e with two conductors, where each conductor is coupled to a corresponding conductor of S/U bus 310 of fuel cell system 100. Placed between power generation module 110e and FC bus 305 and S/U bus 310 is power disconnect module 135e.

Power disconnect module 135e includes a switch 405 on each conductor of module FC bus 307e and module S/U bus 312e. The switches 405 break the electrical connection of the corresponding conductor between power generation module 110e and the corresponding conductor of FC bus 305 or S/U bus 310. Additionally, connections to module FC bus 307e and the ground wire provide an indication of whether power is being conducted (e.g., whether corresponding switch 405 is open or closed) that is visually shown by FC bus indicator light 210. In some embodiments, FC bus indicator light 210 includes one or more indicator lights such as light emitting diodes (LEDs) that indicate whether FC bus 307e has current flowing. In some embodiments, the LEDs are connected such that each LED corresponds to a particular conductor, indicating whether any individual conductor has current flowing. Similarly, connections to module S/U bus 312e and the ground wire provide an indication of whether power is being conducted (e.g., whether corresponding switch 405 is open or closed) that is visually shown by S/U bus indicator light 215. In some embodiments, S/U bus indicator light 215 includes one or more indicator lights such as light emitting diodes (LEDs) that indicate whether S/U bus 312e has current flowing. In some embodiments, the LEDs are connected such that each LED corresponds to a particular conductor, indicating whether any individual conductor has current flowing.

FIG. 5 illustrates schematic view 500 of components within power disconnect module 135e. Switches 505, 510, 515, 520, 525 (depicted as switches 405 in FIG. 4) are used to open and close conductors of module FC bus 307e and module S/U bus 312e. Each conductor includes a switch that is coupled via control element 530 to handle 220. Accordingly, when handle 220 is moved from the on position to the off position, each of switches 505, 510, 515, 520, and 525 are substantially simultaneously opened. Similarly, when handle 220 is moved from the off position to the on position, each of switches 505, 510, 515, 520, and 525 are substantially simultaneously closed. FC bus indicator light 210 and S/U bus indicator light 215 illuminate to indicate whether power is flowing on the corresponding conductors. Control element 530 is coupled to handle 220 and each of switches 505, 510, 515, 520, and 525 such that switching handle 220 between the “on” position and the “off” position changes each of switches 505, 510, 515, 520, and 525 substantially simultaneously to reflect the position of handle 220. In some embodiments control element 530 includes a locking mechanism to prevent handle 220 from being switched from the “off” position to the “on” position. In some embodiments, control element 530 may, for example, transform the motion of handle 220 to a motion in a direction corresponding to opening and closing switches 505, 510, 515, 520, 525. In some embodiments, control element 530 may transmit an indication to each switch 505, 510, 515, 520, and 525 of the movement of handle 220. In some embodiments, control element 530 may be coupled to handle 220 such that the mechanical motion of handle 220 is translated to a physical motion in each of switches 505, 510, 515, 520, and 525 to physically open or close the respective switch in coordination with the movement of handle 220.

### EXAMPLES

The following illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this Specification. As used below, any reference to a series of examples is to be understood as a reference to each of those examples disjunctively (e.g., “Examples 1-4” is to be understood as “Examples 1, 2, 3, or 4”).

Example 1 is an electrochemical fuel cell system, comprising: a first bus comprising two current conductors; a second bus comprising three current conductors; a power conditioning module coupled to the first bus and the second bus; a power generation module, comprising: a module first bus comprising two current conductors each coupled to a corresponding one of the two current conductors of the first bus, and a module second bus comprising three current conductors each coupled to a corresponding one of the three current conductors of the second bus; and a power module disconnect associated with the power generation module, wherein the power module disconnect comprises: a plurality of switches, wherein two switches of the plurality of switches controls a corresponding one of the two current conductors of the module first bus and three switches of the plurality of switches controls a corresponding one of the three current conductors of the module second bus, and a manual switch component configured to control the plurality of switches simultaneously by alternating between an off position and an on position, wherein: in the on position, the module first bus of the power generation module is connected to the first bus and the module second bus of the power generation module is connected to the second bus; and in the off position, the module first bus of the power generation module is disconnected from the first bus and the module second bus of the power generation module is disconnected from the second bus.

Example 2 is the electrochemical fuel cell system of any previous or subsequent claim, wherein: the first bus is a direct current (DC) startup bus; and the second bus is a DC fuel cell bus.

Example 3 is the electrochemical fuel cell system of any previous or subsequent claim, wherein: the power generation module is a first power generation module of a plurality of power generation modules; the power module disconnect is a first power module disconnect of a plurality of power module disconnects; and each power generation module of the plurality of power generation modules is associated with a power module disconnect of the plurality of power module disconnects.

Example 4 is the electrochemical fuel cell system of any previous or subsequent claim, further comprising: a system frame, comprising: one or more disconnect module bays; and one or more power generation module platforms, wherein: the power generation module is supported by a power generation module platform of the one or more power generation module platforms; and the power module disconnect is disposed within a disconnect module bay of the one or more disconnect module bays.

Example 5 is the electrochemical fuel cell system of any previous or subsequent claim, wherein: each of the one or more power generation module platforms has a corresponding disconnect module bay disposed such that a particular power module disconnect disposed within the disconnect module bay is accessible during operation of the electrochemical fuel cell system and visually corresponds to a particular power generation module supported by the corresponding power generation module platform.

Example 6 is the electrochemical fuel cell system of any previous or subsequent claim, wherein: a second power generation module platform of the one or more power generation module platforms is empty; and the electrochemical fuel cell system further comprises: a second power module disconnect disposed within a second disconnect module bay of the one or more disconnect module bays, wherein: the second power module disconnect is associated with the second power generation module platform.

Example 7 is the electrochemical fuel cell system of any previous or subsequent claim, wherein the power module disconnect further comprises: a first bus indicator light configured to indicate current flowing on the module first bus when lit.

Example 8 is the electrochemical fuel cell system of any previous or subsequent claim, wherein the first bus indicator light comprises two light emitting diodes, wherein each light emitting diode of the two light emitting diodes is coupled to a corresponding conductor of the two current conductors of the module first bus.

Example 9 is the electrochemical fuel cell system of any previous or subsequent claim, wherein the power module disconnect further comprises: a second bus indicator light configured to indicate current flowing on the module second bus when lit.

Example 10 is the electrochemical fuel cell system of any previous or subsequent claim, wherein the second bus indicator light comprises three light emitting diodes, wherein each light emitting diode of the three light emitting diodes is coupled to a corresponding conductor of the three current conductors of the module second bus.

Example 11 is the electrochemical fuel cell system of any previous or subsequent claim, wherein the manual switch component comprises a handle that rotates to alternate between the on position and the off position.

Example 12 is the electrochemical fuel cell system of any previous or subsequent claim, wherein the manual switch component further comprises a control element coupled to the handle and coupled to each of the plurality of switches and configured to physically open each of the plurality of switches when the handle is rotated to the off position.

Example 13 is an electrochemical fuel cell system, comprising: a first bus comprising a first plurality of current conductors; a second bus comprising a second plurality of current conductors; a power conditioning module coupled to the first plurality of current conductors of the first bus and the second plurality of current conductors of the second bus; a power generation module; and a power module disconnect, wherein the power module disconnect comprises: a plurality of switches, wherein: a first subset of the plurality of switches controls connection between a corresponding one of a first plurality of current conductors of a module first bus and the first plurality of current conductors of the first bus, a second subset of the plurality of switches controls connection between a corresponding one of a second plurality of current conductors of a module second bus and the second plurality of current conductors of the second bus, and a manual switch component configured to control the plurality of switches simultaneously by alternating between an off position and an on position, wherein: in the on position, the module first bus is connected to the first bus and the module second bus is connected to the second bus; and in the off position, the module first bus is disconnected from the first bus and the module second bus is disconnected from the second bus.

Example 14 is the electrochemical fuel cell system of any previous or subsequent claim, further comprising: a system frame, comprising: one or more disconnect module bays; and one or more power generation module platforms, wherein: the power generation module is supported by a power generation module platform of the one or more power generation module platforms; the power module disconnect is disposed within a disconnect module bay of the one or more disconnect module bays; and the power module disconnect is associated with an empty power generation module platform.

Example 15 is the electrochemical fuel cell system of any previous or subsequent claim, wherein the power module disconnect further comprises: a first bus indicator light configured to indicate current flowing on the module first bus when lit.

Example 16 is the electrochemical fuel cell system of any previous or subsequent claim, wherein the first bus indicator light comprises two light emitting diodes, wherein each light emitting diode of the two light emitting diodes is coupled to a corresponding conductor of the two current conductors of the module first bus.

Example 17 is the electrochemical fuel cell system of any previous or subsequent claim, wherein the power module disconnect further comprises: a second bus indicator light configured to indicate current flowing on the module second bus when lit.

Example 18 is the electrochemical fuel cell system of any previous or subsequent claim, wherein the second bus indicator light comprises three light emitting diodes, wherein each light emitting diode of the three light emitting diodes is coupled to a corresponding conductor of the three current conductors of the module second bus.

Example 19 is the electrochemical fuel cell system of any previous or subsequent claim, wherein the manual switch component comprises a handle that rotates to alternate between the on position and the off position.

Example 20 is the electrochemical fuel cell system of any previous or subsequent claim, wherein the manual switch component further comprises a control element coupled to the handle and coupled to each of the plurality of switches and configured to physically open each of the plurality of switches when the handle is rotated to the off position.

The aforementioned discussion is presented to enable any person skilled in the art to make and use the technology disclosed and is provided in the context of a particular application and its requirements. Various modifications to the disclosed implementations will be readily apparent to those skilled in the art, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein.

Unless the context clearly requires otherwise, throughout the description and the claims, the words "comprise," "comprising," and the like are to be construed in an inclusive sense, as opposed to an exclusive or exhaustive sense; that is to say, in the sense of "including, but not limited to." As used herein, the terms "connected," "coupled," or any variant thereof means any connection or coupling, either direct or indirect, between two or more elements; the coupling or connection between the elements can be physical, logical, or a combination thereof. Additionally, the words "herein," "above," "below," and words of similar import, when used in this application, refer to this application as a whole and not to any particular portions of this application. Where the context permits, words in the above Detailed Description using the singular or plural number may also include the plural or singular number, respectively. The word "or" in reference to a list of two or more items, covers all of the following interpretations of the word: any of the items in the list, all of the items in the list, and any combination of the items in the list.

The phrases "in some embodiments," "according to some embodiments," "in the embodiments shown," "in other embodiments," and the like generally mean the particular feature, structure, or characteristic following the phrase is included in at least one implementation of the present technology and may be included in more than one implementation. In addition, such phrases do not necessarily refer to the same embodiments or different embodiments.

The above detailed description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

What is claimed is:

1. An electrochemical fuel cell system, comprising:
a first bus comprising two current conductors;
a second bus comprising three current conductors;
a power conditioning module coupled to the first bus and the second bus;
a power generation module, comprising:
a module first bus comprising two current conductors each coupled to a corresponding one of the two current conductors of the first bus, and
a module second bus comprising three current conductors each coupled to a corresponding one of the three current conductors of the second bus; and
a power module disconnect associated with the power generation module, wherein the power module disconnect comprises:
a plurality of switches, wherein two switches of the plurality of switches controls a corresponding one of the two current conductors of the module first bus and three switches of the plurality of switches controls a corresponding one of the three current conductors of the module second bus, and
a manual switch component configured to control the plurality of switches simultaneously by alternating between an off position and an on position, wherein:
in the on position, the module first bus of the power generation module is connected to the first bus and the module second bus of the power generation module is connected to the second bus; and
in the off position, the module first bus of the power generation module is disconnected from the first bus and the module second bus of the power generation module is disconnected from the second bus.

2. The electrochemical fuel cell system of claim 1, wherein:
the first bus is a direct current (DC) startup bus; and
the second bus is a DC fuel cell bus.

3. The electrochemical fuel cell system of claim 1, wherein:
the power generation module is a first power generation module of a plurality of power generation modules;
the power module disconnect is a first power module disconnect of a plurality of power module disconnects; and
each power generation module of the plurality of power generation modules is associated with a power module disconnect of the plurality of power module disconnects.

4. The electrochemical fuel cell system of claim 1, further comprising:
a system frame, comprising:
one or more disconnect module bays; and
one or more power generation module platforms,
wherein:
the power generation module is supported by a power generation module platform of the one or more power generation module platforms; and
the power module disconnect is disposed within a disconnect module bay of the one or more disconnect module bays.

5. The electrochemical fuel cell system of claim 4, wherein:
each of the one or more power generation module platforms has a corresponding disconnect module bay disposed such that a particular power module disconnect disposed within the disconnect module bay is accessible during operation of the electrochemical fuel cell system and visually corresponds to a particular power generation module supported by the corresponding power generation module platform.

6. The electrochemical fuel cell system of claim 4, wherein:
a second power generation module platform of the one or more power generation module platforms is empty; and
the electrochemical fuel cell system further comprises:
a second power module disconnect disposed within a second disconnect module bay of the one or more disconnect module bays, wherein:
the second power module disconnect is associated with the second power generation module platform.

7. The electrochemical fuel cell system of claim 1, wherein the power module disconnect further comprises:
a first bus indicator light configured to indicate current flowing on the module first bus when lit.

8. The electrochemical fuel cell system of claim 7, wherein the first bus indicator light comprises two light emitting diodes, wherein each light emitting diode of the two light emitting diodes is coupled to a corresponding conductor of the two current conductors of the module first bus.

9. The electrochemical fuel cell system of claim 7, wherein the power module disconnect further comprises:
a second bus indicator light configured to indicate current flowing on the module second bus when lit.

10. The electrochemical fuel cell system of claim 9, wherein the second bus indicator light comprises three light emitting diodes, wherein each light emitting diode of the three light emitting diodes is coupled to a corresponding conductor of the three current conductors of the module second bus.

11. The electrochemical fuel cell system of claim 1, wherein the manual switch component comprises a handle that rotates to alternate between the on position and the off position.

12. The electrochemical fuel cell system of claim 11, wherein the manual switch component further comprises a control element coupled to the handle and coupled to each of the plurality of switches and configured to physically open each of the plurality of switches when the handle is rotated to the off position.

13. An electrochemical fuel cell system, comprising:
a first bus comprising a first plurality of current conductors;
a second bus comprising a second plurality of current conductors;
a power conditioning module coupled to the first plurality of current conductors of the first bus and the second plurality of current conductors of the second bus;
a power generation module; and
a power module disconnect, wherein the power module disconnect comprises:
a plurality of switches, wherein:
a first subset of the plurality of switches controls connection between a corresponding one of a first plurality of current conductors of a module first bus and the first plurality of current conductors of the first bus,
a second subset of the plurality of switches controls connection between a corresponding one of a second plurality of current conductors of a module second bus and the second plurality of current conductors of the second bus, and
a manual switch component configured to control the plurality of switches simultaneously by alternating between an off position and an on position, wherein:
in the on position, the module first bus is connected to the first bus and the module second bus is connected to the second bus; and
in the off position, the module first bus is disconnected from the first bus and the module second bus is disconnected from the second bus.

14. The electrochemical fuel cell system of claim 13, further comprising:
a system frame, comprising:
one or more disconnect module bays; and
one or more power generation module platforms,
wherein:
the power generation module is supported by a power generation module platform of the one or more power generation module platforms;
the power module disconnect is disposed within a disconnect module bay of the one or more disconnect module bays; and
the power module disconnect is associated with an empty power generation module platform.

15. The electrochemical fuel cell system of claim 13, wherein the power module disconnect further comprises:
a first bus indicator light configured to indicate current flowing on the module first bus when lit.

16. The electrochemical fuel cell system of claim 15, wherein the first bus indicator light comprises a first plurality of light emitting diodes, wherein each light emitting diode of the first plurality of light emitting diodes is coupled to a corresponding conductor of the first plurality of current conductors of the module first bus.

17. The electrochemical fuel cell system of claim 15, wherein the power module disconnect further comprises:
a second bus indicator light configured to indicate current flowing on the module second bus when lit.

18. The electrochemical fuel cell system of claim 17, wherein the second bus indicator light comprises a second plurality of light emitting diodes, wherein each light emitting diode of the second plurality of light emitting diodes is coupled to a corresponding conductor of the second plurality of current conductors of the module second bus.

19. The electrochemical fuel cell system of claim 13, wherein the manual switch component comprises a handle that rotates to alternate between the on position and the off position.

20. The electrochemical fuel cell system of claim 19, wherein the manual switch component further comprises a control element coupled to the handle and coupled to each of the plurality of switches and configured to physically open each of the plurality of switches when the handle is rotated to the off position.
